(19) United States
(12) Patent Application Publication
(10) Pub. No.: US 2017/0367404 A1
(43) Pub. Date: Dec. 28, 2017

(54) ROTARY SWITCH ELECTRONIC CIGARETTE

(71) Applicant: Lrider Technology Co.,Ltd, Shenzhen (CN)

(72) Inventor: Yongsheng LI, Shenzhen (CN)

(73) Assignee: Lrider Technology Co.,Ltd, Shenzhen (CN)

(21) Appl. No.: 15/193,106

(22) Filed: Jun. 27, 2016

(51) Int. Cl. A24F 47/00; H05B 1/02; G08B 5/36

(52) U.S. Cl. CPC A24F 47/008; G08B 5/36; H05B 1/0244

(57) ABSTRACT

A rotary switch electronic cigarette includes a cylindrical electronic cigarette body, wherein: the electronic cigarette body from top to bottom is divided into a retractable smoking nozzle portion, an electric heating portion, and a rotary switch controlling portion. The retractable smoking nozzle portion snaps on the electrically retractable smoking nozzle portion, and snaps on an upper end of the rotary switch controlling portion. The electric heating portion is connected to an upper end of the rotary switch controlling portion in a screw thread manner. The invention has the aesthetical appearance, overall compact design, and is clean and hygiene, convenient to carry, easy to use and observe, wherein the tobacco shred and ash are not likely to leak.

### TECHNICAL FIELD

The present invention relates to the technical field of electronic cigarette, and more specifically, to a rotary switch electronic cigarette.

### BACKGROUND

Since the 18th century, tobacco was introduced to China. Tobacco has a history of more than 300 years. As the time passed by, all kinds of smoking tools emerged endlessly, each of which has its own function. Take the electronic cigarette market as an example, the traditional electronic cigarette nozzle usually exposes to the outside. Not only the smoking nozzle is vulnerable to pollution and thus unhygienic, but also the overall length of the electronic cigarette is increased. It is not convenient to carry. Meanwhile, in terms of smoking control, performing the control of smoking with a small push or push-pull switch manner, it is very difficult and inconvenient to use. Also, it lacks an apparent smoke observation window and a working indicator light, resulting in an unsatisfied smoking experience. At the same time, in terms of PCBA control, it lacks a variety of effective protection circuit to protect the long-term use of the heating element and rechargeable batteries, and therefore it is likely to be burned.

### SUMMARY

In order to overcome the above drawbacks of the prior art, an object of the present invention is to provide a rotary switch electronic cigarette with aesthetical appearance, overall compact design, which is clean and hygiene, convenient to carry, and easy to use and observe, wherein the tobacco shred and ash are not likely to leak.

The technical solution used by the present invention to solve the technical problem is:

A rotary switch electronic cigarette includes a cylindrical electronic cigarette body, wherein: the electronic cigarette body from top to bottom is divided into a retractable smoking nozzle portion, an electric heating portion, and a rotary switch controlling portion. The retractable smoking nozzle portion snaps on the electrically retractable smoking nozzle portion, and snaps on an upper end of the rotary switch controlling portion. The electric heating portion is connected to an upper end of the rotary switch controlling portion in a screw thread manner.

As a further improvement of the present invention, the retractable smoking nozzle portion includes a vertically retractable smoking nozzle, a lid decorative tube, and a glass tube, the smoking nozzle being clamped on an inlet of an upper end of the lid decorative tube, the glass tube engaging within the lid decorative tube, a lower end of the lid decorative tube engaging the electric heating portion, and snapping on an upper end of rotary switch controlling portion, the lid decorative tube including a hollow leaf-shape observation window on a surface of a periphery.

As a further improvement of the present invention, the electric heating portion includes a heating element, a ceramic base cup, a replacement core threaded tube base, and a ceramic protective sleeve, the heating element being fixed to the bottom of a heating cavity of the ceramic base cup, the ceramic base cup snapping inside the ceramic protective sleeve, the ceramic protective sleeve snapping on an upper end of the replacement core threaded tube base, an upper end of the ceramic protective cover also being provided with an air permeable and leaking proof lid, an lower end of the replacement core threaded tube base is a threaded tube, the replacement core threaded tube base being fastened inside an upper end of the rotary switch controlling portion through the threaded tube at the lower end, an upper electrode contact core pole being clamped inside the threaded tube, the upper electrode contact core pole being connected to the heating element by a lead.

As a further improvement of the present invention, the rotary switch controlling portion includes a rotary switch assembly, a battery sleeve, a rechargeable battery, a PCBA control panel, and a battery base. The rotary switch assembly is mounted above the battery sleeve. The rechargeable battery is fixed to a middle portion of the battery sleeve. The battery base engages a bottom of the battery sleeve. An upper portion of the battery base is provided with a circle translucent region. The PCBA control panel is provided with a green indicator light, and is fixed on battery base. The PCBA control board is connected to the rotary switch assembly and the rechargeable battery via a lead. The bottom of the battery base is also provided with a charging port. An upper end of the rotary switch assembly is connected to the lower end of the lid decorative tube in a snap-fit manner.

As a further improvement of the present invention, the rotary switch assembly includes a lid rotating snap ring, a rotating base, a battery rotating base, a rotating clamp base, and a rotary switch. The lid rotating snap ring snaps on an upper end of the rotating base. The rotating base is clamped on the battery rotating base. The battery rotating base is fixed on an upper portion of the battery sleeve. An upper end of the battery rotating base is connected to the threaded tube of the replacement core threaded tube base through an inner thread. A central portion of the rotating base also is clamped with a lower electrode contact core pole. The lower electrode contact core pole is clamped on a central portion of the rotating base by a lower insulating sleeve. A lower end of the rotating base clamps the rotating clamp base, rotating clamp base turning the rotary switch by a lower paddle. A middle portion of the rotating clamp base is provided with a rotation limit clamp slot. The rotary switch is connected to the PCBA control panel through a lead.

As a further improvement of the present invention, the PCBA control panel is provided with a time-out protection circuit, a low-voltage protection circuit, a short circuit protection, and an overload protection circuit.

Compared with the prior art, the beneficial effects of the present invention lie in:

1. The present invention generally uses a pillared design simulating the cigarette shape. Moreover, a hollow type observation window in a shape of the green leaf is provided. The appearance is aesthetical. Meanwhile, in conjunction with a retractable smoking nozzle, the overall size of the electronic cigarette is more compact than the ordinary product, and thus it is easy to carry.

2. The present invention uses a rotary switch manner to enable or disable the smoking. Compared with the normal opening or closing manner by pressing or sliding a switch, it is easier and more convenient. With the cover decorative tube engaging on a rotary switch assembly, manually rotating the switch assembly will open or close the PCBA control panel. Meanwhile, in conjunction with a green-leaf-shaped observation window, the inside smoke can be seen clearly when opening. Also, through the transparent region on an upper portion of the base of the battery, changes of the green indicator light can be observed, so as to now the using status of the electronic cigarette. Therefore, it is very easy to use and observe.

3. A retractable smoking nozzle structure is used. When it is not in use, the nozzle can indent into the tube, so as to avoid dirty the smoking nozzle. When it is in use, the nozzle is pulled out. Thus, it is very clean and hygiene, and easy to carry.

4. In the upper portion of the inner cavity where the tobacco burns, that is, the upper end of a ceramic protective sleeve, an air permeable and leaking proof lid is provided. It can prevent the leakage or the sucking out of the tobacco shred or ash from the smoking nozzle, such that a using angle of smoking is unconstrained.

5. The PCBA control panel of the present invention has a variety of protection circuits, such that the heating element and a rechargeable power supply can be effectively protected, so that the electronic cigarette is more durable.

### BRIEF DESCRIPTION OF THE DRAWINGS

FIG. 1 is a schematic view of the structure of the present invention;

FIG. 2 is a cross-sectional schematic view of the structure of the invention;

FIG. 3 is a schematic view of the overall assembly of the invention.

### DETAILED DESCRIPTION

Hereinafter, the invention is further described in conjunction with Figures and examples:

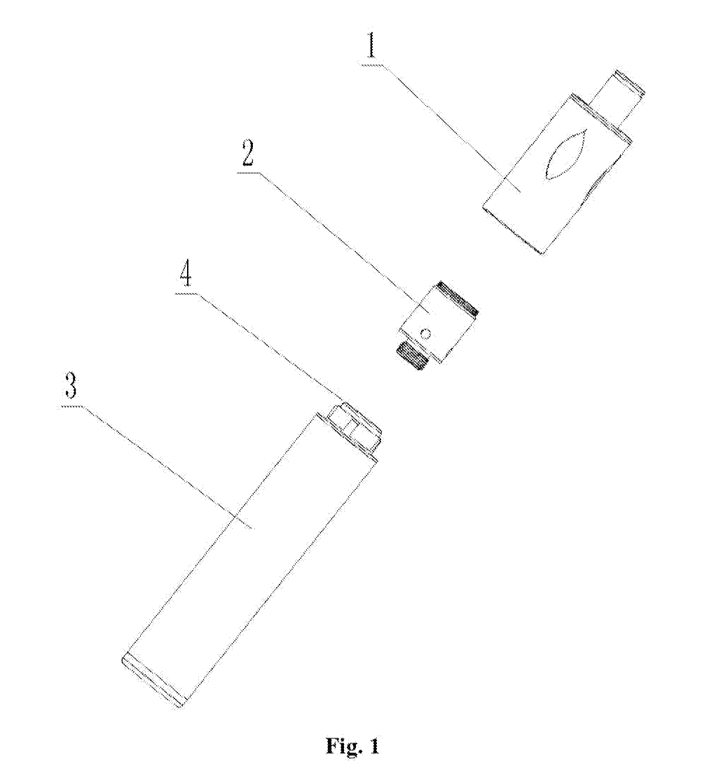

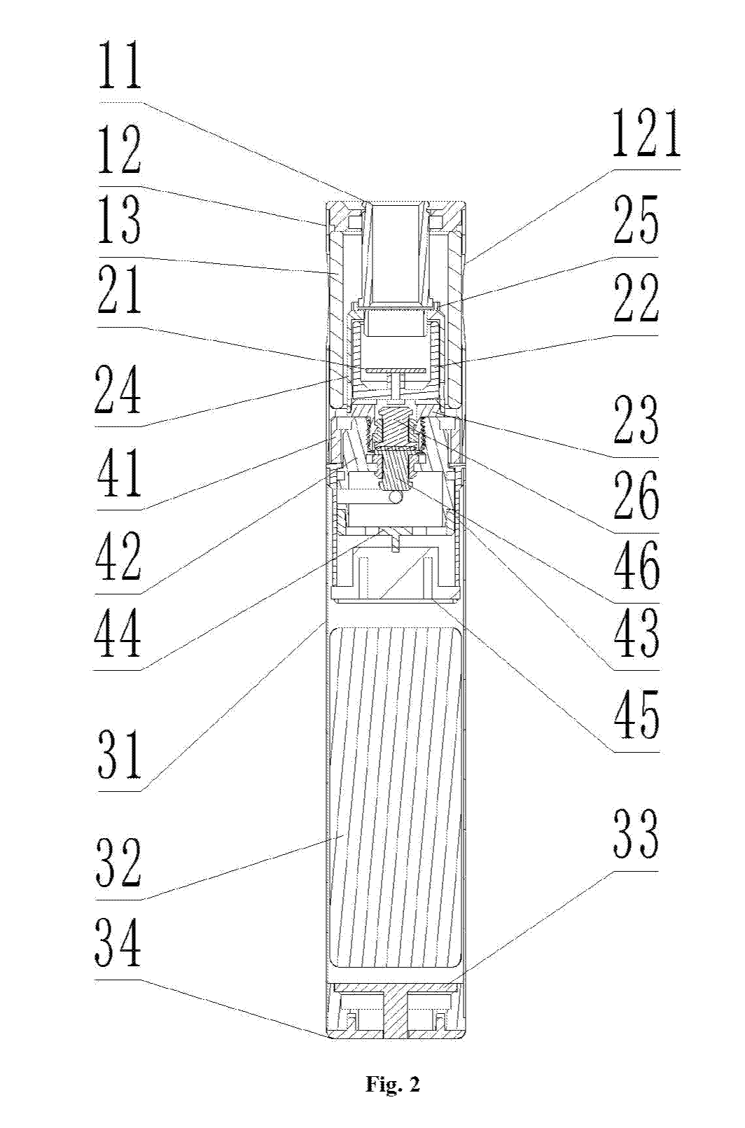

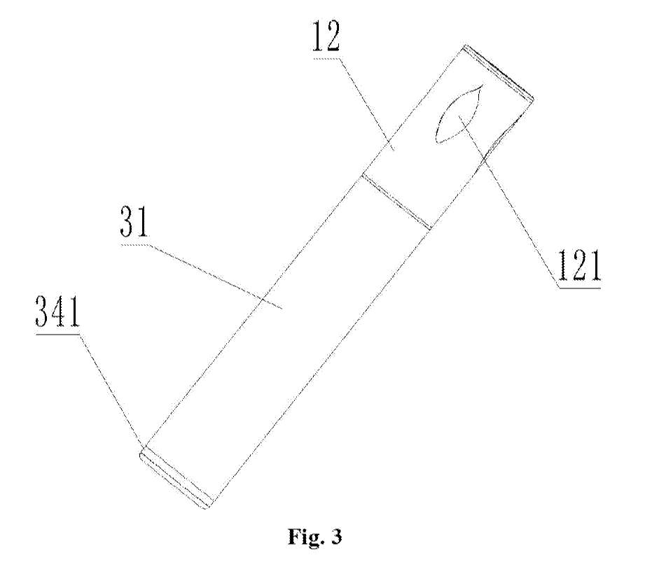

With reference to FIGS. 1 to 3, a rotary switch electronic cigarette includes a cylindrical electronic cigarette body, wherein the electronic cigarette body from top to bottom is divided into retractable smoking nozzle portion 1, electric heating portion 2, and rotary switch controlling portion 3. Retractable smoking nozzle portion 1 covers and snaps on electric heating portion 2, and snaps on an upper end of rotary switch controlling portion 3. Electric heating portion 2 is connected to an upper end of rotary switch controlling portion 3 in a screw thread manner.

Retractable smoking nozzle portion 1 includes a vertically retractable smoking nozzle 11, lid decorative tube 12 and glass tube 13. Smoking nozzle 11 is clamped at the inlet of the upper end of the lid decorative tube 12. Glass tube 13 engages within the lid decorative tube 12. The lower end of lid decorative tube 12 engages electric heating portion 2, and snaps on the upper end of rotary switch controlling portion 3. Lid decorative tube 12 has hollow leaf-shape observation window 121 on the surface of the periphery.

Electric heating portion 2 includes heating element 21, ceramic base cup 22, replacement core threaded tube base 23, and ceramic protective sleeve 24. Heating element 21 is fixed to the bottom of the heating cavity of ceramic base cup 22. Ceramic base cup 22 snaps inside ceramic protective sleeve 24. Ceramic protective sleeve 24 snaps on the upper end of replacement core threaded tube base. The upper end of ceramic protective cover 24 is also provided with air permeable and leaking proof lid 25. The lower end of replacement core threaded tube base 23 is a threaded tube. Replacement core threaded tube base 23 is fastened inside the upper end of rotary switch controlling portion 3 through the threaded tube at its lower end upper electrode contact core pole 26 is clamped inside the threaded tube. Upper electrode contact core pole 26 is connected to heating element 21 by a lead.

Rotary switch controlling portion 3 includes a rotary switch assembly 4, battery sleeve 31, rechargeable battery 32, PCBA control panel 33, and battery base 34. Rotary switch assembly 4 is mounted above battery sleeve 31. Rechargeable battery 32 is fixed to the middle of battery sleeve 31. Battery base 34 covers and engages the bottom of battery sleeve 3. The upper portion of battery base 34 is provided with circular translucent region 341. PCBA control panel 33 is provided with a ween indicator light, and is fixed on battery base 34. PCBA control board 33 is connected to rotary switch assembly 4 and rechargeable battery 32 via the lead. The bottom of battery base 34 is also provided with the charging port. The upper end of rotary switch assembly 4 is connected to the lower end of lid decorative tube 12 in a snap-fit manner.

Rotary switch assembly 4 includes lid rotating snap ring 41, rotating base 42, battery rotating base 43, rotating; damp base 44, and rotary switch 45, lid rotating snap ring 41 snaps on the upper end of rotating base 42. Rotating base 42 is clamped on battery rotating base 43. Battery rotating base 43 is fixed on the upper portion of battery sleeve 31. The upper end of the battery rotating base 42 is connected to the threaded tube of replacement core threaded tube base 23 through the inner thread. The central portion of rotating base 42 is also clamped with lower electrode contact core pole 46. Lower electrode contact core pole 46 is clamped on the central portion of rotating base 42 by lower insulating sleeve. The lower end of rotating base 42 clamps rotating clamp base 44. Rotating clamp base 44 turns the rotary switch 45 by a lower paddle. The middle portion of rotating clamp base 45 is provided with rotation limit clamp slot. Rotary switch 45 is connected to PCBA control panel 33 through the lead.

PCBA control panel 33 is provided with a time-out protection circuit, a low-voltage protection circuit, a short circuit protection, and an overload protection circuit.

Detailed implementation:

Adding tobacco shred: when it is in use, from the controlling portion of the rotary switch, the retractable smoking nozzle portion is pulled out, while the smoking nozzle is also pulled out. Meanwhile, the tobacco shred is put into the heating cavity of the ceramic base cup. After the tobacco shred is put in, the retractable smoking nozzle portion is clamped on the upper end of the controlling portion of the rotary switch again.

Turning on the switch: the lid decorative tube is turned 90 degrees clockwise. With the rotation of the lid decorative tube, the rotary switch of the rotary switch assembly is driven to rotate to enable the operation of the PCBA control panel. The heating element starts working to generate heat. Now, through the translucent region of the upper portion of the base battery, the green indicator light can be observed as shining. The smoke can also be seen through the window of the lid decorative tube, showing that the electronic cigarette is in a working status which can be smoked.

Timeout protection: after the PCBA control panel has continuously worked for 30 seconds, the timeout protection circuit controls the PCBA control panel to stop the output. The green indicator light flashes five times to indicate this.

Short circuit protection and overload protection: when the PCBA control panel detects that the load is short-circuited or less than 0.5Ω, through short circuit protection circuit or overload protection circuit controls the PCBA control panel to stop the output. The green indicator light flashes three times to indicate this.

Low voltage protection: when the PCBA control panel detects that the rechargeable battery voltage is lower than 3.4V using the low voltage detecting circuit, it controls the PCBA control panel to stop the output. Meanwhile, the green indicator light flashes eight times to indicate this.

Turning off the switch: the lid decorative tube is turned 90 degrees counter-clockwise by rotating the lid decorative tube, and the rotary switch of the rotary switch assembly is driven to rotate to disable the operation of the PCBA control panel. The heating element stops generating heat. The green light goes out.

In summary, after reading the present invention documents, according to the technical solution and the technical idea of the present invention, a variety of other alternative solutions made by one of ordinary skill in the art without creative efforts, are within the scope of the present invention.

What is claimed is:

1. A rotary switch electronic cigarette, comprising a cylindrical electronic cigarette body, wherein: the electronic cigarette body from top to bottom is divided into a retractable smoking nozzle portion, an electric heating portion, and a rotary switch controlling portion, the retractable smoking nozzle portion snapping on the electrically retractable smoking nozzle portion, and snapping on an upper end of the rotary switch controlling portion, the electric heating portion being connected to an upper end of the rotary switch controlling portion in a screw thread mariner.

2. The rotary switch electronic cigarette according to claim 1, wherein: the retractable smoking nozzle portion includes a vertically retractable smoking nozzle, a lid decorative tube, and a glass tube, the smoking nozzle being clamped on an inlet of an upper end of the lid decorative tube, the glass tube engaging within the lid decorative tube, a lower end of the lid decorative tube engaging the electric heating portion, and snapping on an upper end of rotary switch controlling portion, the lid decorative tube including a hollow leaf-shape observation window on a surface of a periphery.

3. The rotary switch electronic cigarette according to claim 1, wherein: the electric heating portion includes a heating element, a ceramic base cup, a replacement core threaded tube base, and a ceramic protective sleeve, the heating element being fixed to a bottom of a heating cavity of the ceramic base cup, the ceramic base cup snapping inside the ceramic protective sleeve, the ceramic protective sleeve snapping on an upper end of the replacement core threaded tube base, an upper end of the ceramic protective cover also being provided with an air permeable and leaking proof lid, an lower end of the replacement core threaded tube base is a threaded tube, the replacement core threaded tube base being fastened inside an upper end of the rotary switch controlling portion through the threaded tube at the lower end, an upper electrode contact core pole being clamped inside the threaded tube, the upper electrode contact core pole being connected to the heating element by a lead.

4. The rotary switch electronic cigarette according to claim 1, wherein: the rotary switch controlling portion includes a rotary switch assembly, a battery sleeve, a rechargeable battery, a PCBA control panel, and a battery base, the rotary switch assembly being mounted above the battery sleeve, the rechargeable battery being fixed to a middle portion of the battery sleeve, the battery base engaging a bottom of the battery sleeve, an upper portion of the battery base being provided with a circle translucent region, the PCBA control panel being provided with a green indicator light, and being fixed on battery base, the PCBA control board being connected to the rotary switch assembly and the rechargeable battery via a lead, a bottom of the battery base also being provided with a charging port, an upper end of the rotary switch assembly being connected to the lower end of the lid decorative tube in a snap-fit manner.

5. The rotary switch electronic cigarette according to claim 4, wherein: the rotary switch assembly includes a lid rotating snap ring, a rotating base, a battery rotating base, a rotating clamp base, and a rotary switch, the lid rotating snap ring snapping on an upper end of the rotating base, the rotating base being clamped on the battery rotating base, the battery rotating base being fixed on an upper portion of the battery sleeve, an upper end of the battery rotating base being connected to the threaded tube of the replacement core threaded tube base through an inner thread, a central portion of the rotating base also being clamped with a lower electrode contact core pole, the lower electrode contact core pole being clamped on a central portion of the rotating base by a lower insulating sleeve, a lower end of the rotating base clamping the rotating clamp base, rotating clamp base turning the rotary switch by a lower paddle, a middle portion of the rotating clamp base being provided with a rotation limit clamp slot, the rotary switch being connected to the PCBA control panel through a lead.

6. The rotary switch electronic cigarette according to claim 4, wherein: the PCBA control panel is provided with a time-out protection circuit, a low-voltage protection circuit, a short circuit protection, and an overload protection circuit.
